(19) United States
(12) Patent Application Publication
(10) Pub. No.: US 2014/0331670 A1
(43) Pub. Date: Nov. 13, 2014

(54) ENERGY STORAGE AND RECOVERY SYSTEM

(71) Applicant: IMPRESSIVE ENGINEERING LIMITED, Kingswells, Aberdeen (GB)

(72) Inventor: Kasra Zarisfi, Kingswells (GB)

(73) Assignee: IMPRESSIVE ENGINEERING LIMITED, Kingswells, Aberdeen (GB)

(21) Appl. No.: 14/361,848

(22) PCT Filed: Feb. 4, 2013
(86) PCT No.: PCT/GB2013/050253

§ 371 Date: May 30, 2014

(30) Foreign Application Priority Data
Feb. 2, 2012 (GB) GB12018511
Dec. 12, 2012 (GB) GB12223459
Dec. 12, 2012 (GB) GB12223467

(51) Int. Cl. F03D 9/02; F03G 3/00

(52) U.S. Cl. CPC F03D 9/025; F03G 3/00
USPC 60/639

(57) ABSTRACT

An energy storage system includes at least one body that is arranged to move along a bore that is excavated underground. The energy storage system includes a seal assembly within the bore. The seal assembly includes a support member and a seal element. The support member is arranged to support the body for movement in two directions within the bore and the seal element is adapted to isolate two regions within the bore from each other. The system also includes a fluid loading system wherein a first fluid and a second fluid can be separately fed to the bore. The first fluid is arranged in use to apply pressure to a first face of the seal element to charge the energy storage system. The second fluid is of heavier density than the first fluid and is arranged to apply pressure to a second face of the seal element. The fluid loading system can control levels of the second fluid within the bore such that when the seal assembly is moved to charge or discharge the system, the pressure difference on the seal element is reduced, thus enabling a more moderate seal element to be used, which minimises friction losses between the seal and a wall of the bore.

### FIELD OF THE INVENTION

The present invention relates to an energy storage and recovery system. More particularly, the present invention relates to a gravitational based energy storage and recovery system utilising a bore excavated underground and a moving mass to store and generate energy.

### BACKGROUND TO THE INVENTION

An example of a known energy storage and recovery system is a pump storage system, which is an example of a gravitational (potential energy) based system. The pump storage system is also known as pumped hydro system and comprises two water reservoirs each situated at a different elevation to each other such that one is higher than the other. Water is pumped from the lower reservoir to the upper reservoir when excess energy is present and as such the excess energy is reserved in the system by holding the water in the upper reservoir. When the energy is required water is released from the upper reservoir to the lower reservoir, generally via a turbine such that mechanical energy is produced by the action of the gravitational flow of water from the upper reservoir to the lower reservoir. The mechanical energy produced can be converted to electrical energy via appropriate means, for example a generator and is then provided to the grid via a substation.

Renewable energy is becoming more and more popular where natural energy sources are captured to be converted to electrical energy. An example of a renewable energy source is wind energy. Wind energy is generally converted to mechanical energy via a wind turbine. The mechanical energy is therefore convertible to useful electrical energy. However, wind energy is a naturally occurring resource and by its nature is very unpredictable. Accordingly, the amount of electrical energy produced by a wind turbine can also be subject to variation over time.

The unpredictable nature of wind energy has encouraged development of energy storage systems that can capture the wind energy and store the energy for use when required rather than lose energy produced at periods when winds are high and energy is not required and similarly, rather than having no power at a period of demand when there is no wind.

An example of an energy storage system that utilises the wind energy to store energy and discharges energy when demanded is provided by a gravitational system where a deep bore is excavated and utilises moving masses within the bore from a first elevation to a second elevation within the bore to generate energy that is convertible to electricity.

Due to conventional power resources, such as coal, oil and gas becoming more expensive and as reserves become depleted renewable energy resources are being explored more and more.

It is therefore desirable to provide an improved renewable energy resource.

It is desirable to provide an energy storage system that is operable with wind energy products.

It is desirable to provide an energy storage system that is capable of producing a substantially constant energy supply from irregular wind energy.

It is also desirable to provide an energy storage system that is capable of matching irregular wind energy production with intermittent energy demand behaviour.

It is further desirable to provide an energy efficient energy storage and recovery system utilising balanced pressure to minimise energy losses due to frictional effects.

### SUMMARY OF INVENTION

According to a first aspect of the present invention there is provided an energy storage and recovery system comprising:

at least one movable body being arranged to move within a bore excavated underground;

a seal assembly arranged to support the at least one body for movement in two directions within the bore, wherein the seal assembly comprises a support member and a seal element, wherein the seal assembly is adapted to isolate two regions within the bore from each other;

a fluid loading system wherein a first fluid and a second fluid can be separately fed to the bore;

wherein in use the first fluid applies pressure adjacent a first face of the seal element, wherein the first fluid can be pressurised to charge the energy storage system;

wherein, in use the second fluid comprises fluid of heavier density than the first fluid and wherein the second fluid applies pressure adjacent a second face of the seal element; and

wherein the fluid loading system is operable to control levels of the second fluid within the bore.

By controlling levels of second fluid within the bore, the pressure difference in the region of the seal element due to the first and second fluids is reduced and pressures in the region of the seal element may be substantially balanced even when the seal assembly is moving due to a normally larger, and an overall, imbalance in force resulting from pressure between the sides of the seal assembly especially the seal support member which is normally a solid structure.

The seal element is subject only to fluid pressure on both faces, therefore loading on the seal element is reduced and may be minimal because pressure on both faces of the seal element is reduced and the effect of pressure on both faces of the seal element is preferably balanced and therefore the effects of the fluid pressure on seal element may be substantially negligible.

As such the energy storage system according to the present invention has improved efficiency over prior art systems because the seal element effectively acts only to keep the first and second fluids apart and therefore does not generate large frictional loads on the inside of the bore. Energy losses due to friction are therefore minimal using the seal assembly of the present invention.

The energy storage system further comprises a fluid loading system wherein the first and second fluids can be separately fed to the bore, wherein the bore comprises a plurality of pipes extending longitudinally at the perimeter of the bore, wherein each pipe is open towards the base of the bore, wherein the first fluid can be fed through the pipes and the second fluid can be fed to the bore. In use the second fluid may surround the at least one body in the bore.

The arrangement of the pipes and the bore creates a U-tube configuration, as such an interface region at the location of the seal element is assured and as such balanced pressure at the seal element and therefore minimal friction between the seal element and the bore is assured.

According to a first embodiment of the present invention, the first fluid may be oil and the second fluid may be a molten metal or a molten metal alloy. Examples of suitable molten metal alloys, for example eutectic alloys are Wood's metal, Field's metal, Cerrolow 136, Cerrolow 117 etc. Preferably, the metal alloy has a relatively low melting point, which is desirable to maintain the alloy in a molten, fluid state such that it can be added and retrieved from the bore during discharging and charging respectively.

Suitable examples for the second fluid may comprise a metal alloy with a low melting point. A low melting point may be in the region of 100 to 120 degrees centigrade. Preferably, a low melting point is 70 degrees centigrade or less.

Examples of the second fluid may comprise a bismuth based alloy, or a fusible alloy, a eutectic alloy, a non-eutectic alloy, mercury or a mercury alloy.

To maintain an alloy as described above as a fluid the temperature of the fluid within the bore should be maintained at least at the melting point temperature of the second fluid. The bore may utilise geothermal energy to heat the metal and to maintain the metal in a fluid state.

Geothermal energy may deliver bore temperatures in the region of 120 to 140 degrees centigrade. Normally the deeper areas of the bore are warmer, and so a liquid can be circulated in a closed tube which may be in a coiled configuration, up along the bore to absorb the geothermal heat from a bottom section of the bore and transfer it to a top section of the bore, where the ambient temperature is below the melting point. (This top section may also be insulated.)

Alternatively, or in addition, heat may be supplied to the bore from an external source. Preferably, any external heat source will be provided using waste energy from ancillary equipment connected to the energy storage system, for example generators, used in converting mechanical energy to electrical energy or pumps used to feed fluids to the system. In addition, the bore may include an insulation liner such that the heat level within the bore is substantially constant and loss of heat within the bore is minimised.

According to a second embodiment of the present invention, the first fluid may be water or the first fluid may be oil and the second fluid may comprise a suspension of particulate material dispersed in an external phase of fluid. The second fluid may comprise a suspension comprising particulate material dispersed in oil or optionally a liquid with a higher viscosity than water.

The particulate material may comprise a metal powder. The metal powder may be iron powder. Alternatively, the metal powder may be lead powder.

To maintain dispersion of the metal powder in the suspension the system may further comprise agitation means operable, in use to agitate the suspension such that settlement/separation of the metal powder from the oil does not occur.

In use, the act of charging or discharging energy may provide partial or full agitation due to movement of the bodies within the bore.

The suspension may fill/occupy an annulus area defined between the bodies and the bore and any gaps between adjacent bodies. As such agitation may occur as a result of the movement of bodies relative to the bore wall because in use a shearing force between the second fluid (suspension) and the bore wall and second fluid and the moving bodies may provide a means of continuous agitation of the suspension.

Alternatively, or in addition, agitation can be provided by an external source such as circulating the suspension using a pump arrangement. A mixing device may be used to stir/agitate the suspension, for example in a holding tank such that the fine particles, or metal powder does not settle.

Where the metal powder comprises iron powder a magnetic system may be employed to provide agitation of the suspension fluid as it moves through the bore. A suitable magnetic source may be provided by a coil wrapped around the bodies. Alternatively, a suitable magnetic source may be provided by a coil wrapped around the bore casing. Using either method, magnetic pulses passing through the coil may be effective in attracting the iron element of the metal powder and thereby agitate the suspension and maintain dispersion of the metal powder in the oil.

Alternatively, a magnetic field may be provided by a permanent magnet arrangement that is operable to rotate or move within the bore.

According to both the first and second embodiments the density of the second fluid and the density of the bodies are approximately equal.

In respect of especially the first embodiment where the second fluid comprises a molten metal, the at least one body may comprise a substantially cylindrical body. The body may be solid. Alternatively, the body may be hollow and may be filled with matter. The body may be made of steel. The body may comprise a hollow cylinder filled with, for example, iron. The hollow cylinder may be made of steel.

Each body may comprise a plurality of roller members distributed substantially evenly about the perimeter of the body. Each roller may be arranged to rotate as the body passes through the bore. Each roller may act to facilitate easier travel of the body through the bore and may also act to maintain spacing of the body from the bore wall to avoid jamming of the body within the bore.

In respect of especially the second embodiment, where the second fluid comprises a suspension of particulate material dispersed in an external phase fluid, the at least one body may comprise a substantially cylindrical body. The body may be solid. Alternatively, the body may be hollow and may be filled with matter. The body may be made of steel. The body may comprise a hollow steel cylinder filled with, for example, concrete. The body may comprise a material composition having a density of approximately 2800 kg/m³. Each body may comprise a plurality of roller members distributed substantially evenly about the perimeter of the body. Each roller may be arranged to rotate as the body passes through the bore. Each roller may act to facilitate easier travel of the body through the bore and may also act to maintain spacing of the body from the bore wall to avoid jamming of the body within the bore.

The bore may comprise a substantially vertical section extending at its base to a substantially horizontal section. The vertical section of the bore may be at least two kilometres deep.

Preferably, the vertical section of the bore is three or more kilometres deep such that naturally occurring geothermal effects may be utilised to maintain the metal or metal alloy in a molten fluid state. The horizontal section may be up to five kilometres long and extends from the bottom of the vertical section such that a continuous path is provided through which the at least one body can travel.

According to the second embodiment, wherein the second fluid comprises a suspension of particulate material dispersed in an external phase fluid, the bore may be substantially vertical. The bore may be at least two kilometres deep. The energy storage system according to the embodiments of the present invention may be utilised with one or more devices used to capture energy and one or more devices for supplying electricity from energy discharged from the energy storage system. For example a wind turbine may be used as a natural system to capture energy, where the captured energy can be utilised to charge the energy storage system; therefore, the energy storage system contains potential energy. By its nature wind energy is not constant, but energy captured by the wind turbine can be conserved and can become substantially constant because the energy produced by the wind turbine can be saved as potential energy by the energy storage system and then upon demand the energy storage system can discharge the energy as mechanical energy that can be converted by suitable means to useful electricity. As such wind turbines coupled with an energy storage system according to the present invention can be more reliable to install and as such being also more reliable to provide supply upon demand and not only when the wind is blowing. Wind energy can therefore be as reliable as other sources of energy such as nuclear or fuel based power stations because the energy storage system is capable of producing a substantially constant amount of electrical energy.

When used with, for example wind turbines, two variables need be considered; namely production and consumption. As discussed above wind energy can be highly unpredictable and as such is not reliable to meet the demands of production and consumption. The energy storage system therefore requires a greater storage capacity such that when production and consumption requirements are mismatched the energy storage system is capable of storing greater levels of energy and where consumption demands are greater the energy storage system can respond to demands. In this way the wind energy resource becomes a more reliable supply upon demand system.

### BRIEF DESCRIPTION OF THE DRAWINGS

Embodiments of the present invention will now be described, by way of example only, with reference to the accompanying drawings, in which:

FIG. 1 illustrates a schematic representation of a charged energy storage system in accordance with a first embodiment of the present invention;

FIG. 2 illustrates a schematic representation of a discharged energy storage system in accordance with a first embodiment of the present invention;

FIG. 3a illustrates a cross sectional plan view of a body used with an energy storage system according to a first embodiment of the present invention;

FIG. 3b illustrates a schematic representation of a longitudinal cross section of a moving body used with the energy storage system according to a first embodiment of the invention.

FIG. 4 illustrates a schematic representation of a seal assembly used with a first embodiment of the present invention when the system is in a static state;

FIG. 5 illustrates a schematic representation of a seal assembly used with a first embodiment of the present invention when the system is charging;

FIG. 6 illustrates a schematic representation of a seal assembly used with a first embodiment of the present invention when the system is discharging;

FIG. 7 illustrates a schematic representation of a discharged energy storage system according to a second embodiment of the present invention;

FIG. 8 illustrates a schematic representation of a charged energy storage system according to a second embodiment of the present invention;

FIG. 9a illustrates a cross sectional plan view of a body used with an energy storage system according to a second embodiment of the present invention;

FIG. 9b illustrates a schematic representation of a longitudinal cross section of a moving body used with the energy storage system according to a second embodiment of the present invention;

FIG. 10 illustrates a schematic representation of a seal assembly used with the energy storage system according to a second embodiment of the present invention when the system is in a static state;

FIG. 11 illustrates a schematic representation of a seal assembly used with the energy storage system according to a second embodiment of the present invention when the system is charging;

FIG. 12 illustrates a schematic representation of a seal assembly used with the energy storage system according to a second embodiment of the present invention when the system is discharging;

FIG. 13a illustrates an application of a charged energy storage and recovery system according to a second embodiment of the present invention as applied to supply energy to a supermarket or shopping centre; and

FIG. 13b illustrates an application of a discharged energy storage and recovery system according to a second embodiment of the present invention as applied to supply energy to a supermarket or shopping centre.

### BRIEF DESCRIPTION

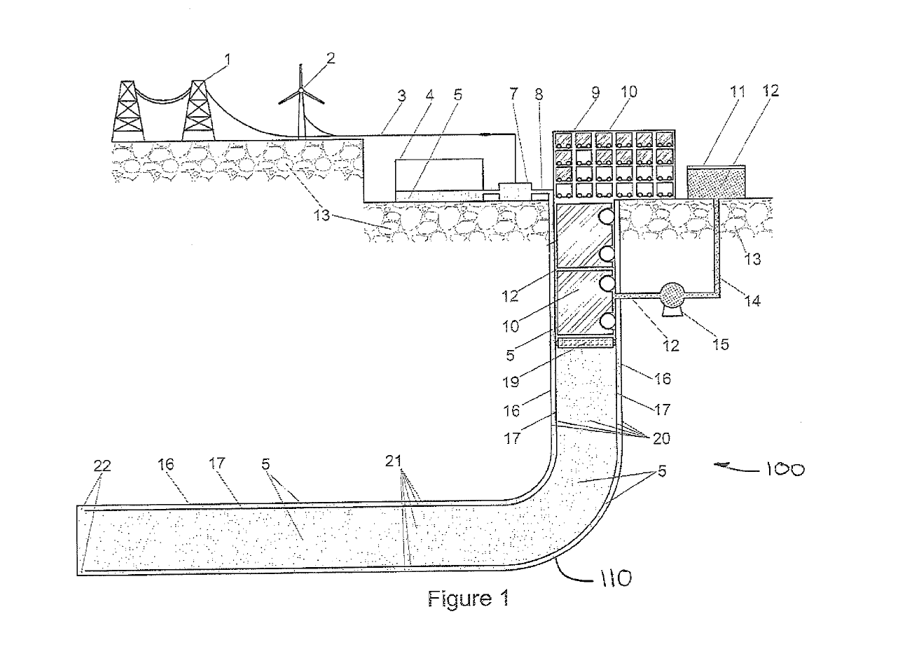

FIG. 1 illustrates an example of an energy storage system 100 in accordance with a first embodiment of the present invention. The energy storage system 100 comprises an L-shaped bore 110 located underground by means of drilling or excavation. In the embodiment illustrated the bore is lined with a steel casing 17 along which moving bodies 10 can be displaced.

In the illustrated embodiment, the bore 110 comprises a vertical section 20 and a horizontal section 21 through which the bodies 10 can move to charge the system 100 with energy or to discharge energy from the system 100. Charging and discharging energy using the system 100 is discussed further below.

With current drilling technology ultra deep wells are achievable. The term ultra deep relates to the term used in oil and gas technology in describing well depth. In the oil and gas industry wells that are 2000 m to 3000 m deep are considered typical.

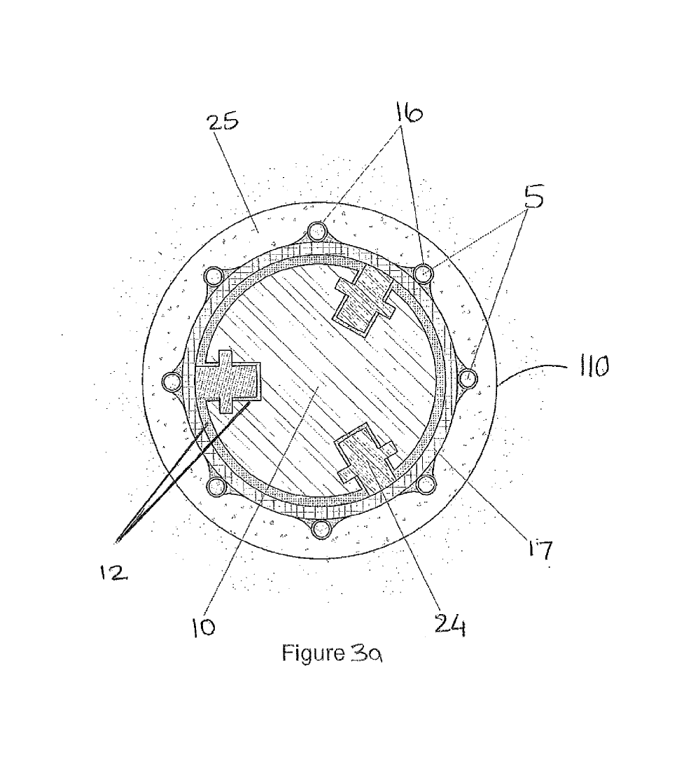

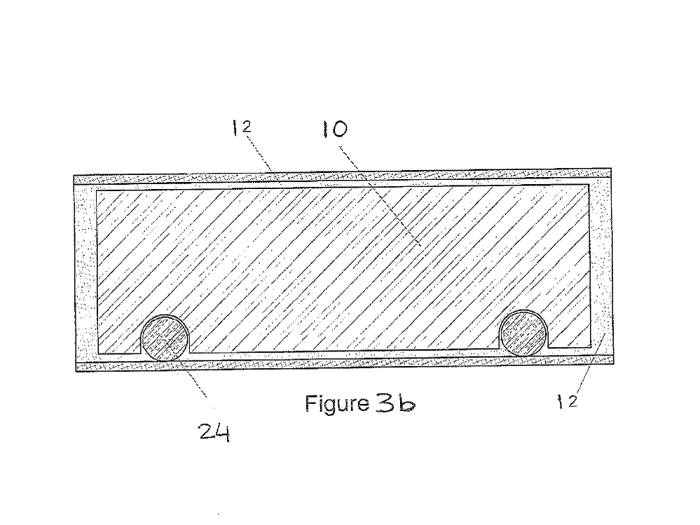

In the illustrated embodiment the bore 110 is formed underground 13 and comprises a vertical section 20 in the region of two kilometres deep and a horizontal section 21 in the region of five kilometres long. The system 100 utilises a U-tube configuration containing two fluids of different densities in upper and lower sections of the bore 110. The U-tube configuration is described further below with reference to FIG. 3a.

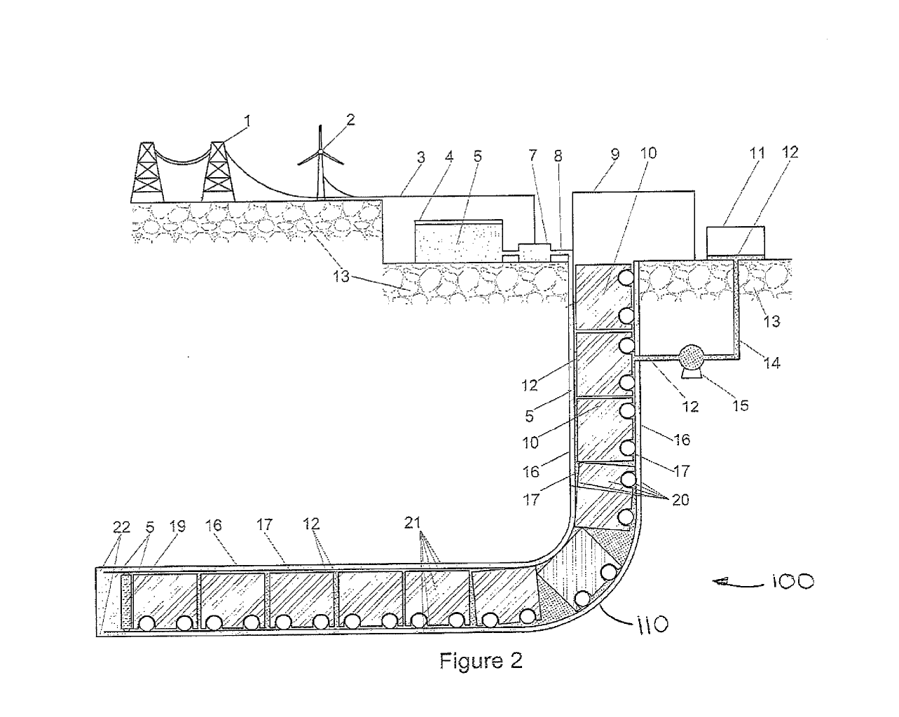

FIGS. 1 and 2 schematically represent an energy storage system 100 connected to the electrical grid 1 and a wind turbine 2. In this particular embodiment the energy storage system 100 captures energy from the wind turbine 2 and stores the energy as potential energy that can then be discharged to the grid for general consumption. The arrangement of the system 100 allows intermittent wind loads to be utilised efficiently such that a valuable natural energy resource is not wasted.

The energy storage system 100 works on a similar principle as the pump storage system described above where energy is stored and discharged by moving a mass/weight within the system. In this example the moving matter is not water, as used in the pump storage system, but instead is a plurality of physical bodies 10, each of which moves up towards the surface through the bore 110 to store energy. And, when there is a demand for energy the bodies 10 are released and move down through the bore 110 due to gravity to discharge energy. In the particular embodiment each body 10 comprises a hollow steel cylinder filled with iron and as such may have an average density of 8000 kg/m³.

In order for the bodies 10 to move along the length of the bore 110, the illustrated embodiment utilises a runner fluid 5 that is fed to the lower regions of the bore 110 (below the bodies 10) via the horizontal section 21 via pipes 16 that extend along the edge of the bore 110 within the casing 17. The pipes 16 are open at the top to receive fluid and open at the bottom 22 to expel fluid 5 into the horizontal section 21 of the bore. The system also utilises a second fluid 12 that is fed to the upper regions of the bore 110 via the vertical section 20 such that the bodies 10 are immersed in the second fluid 12.

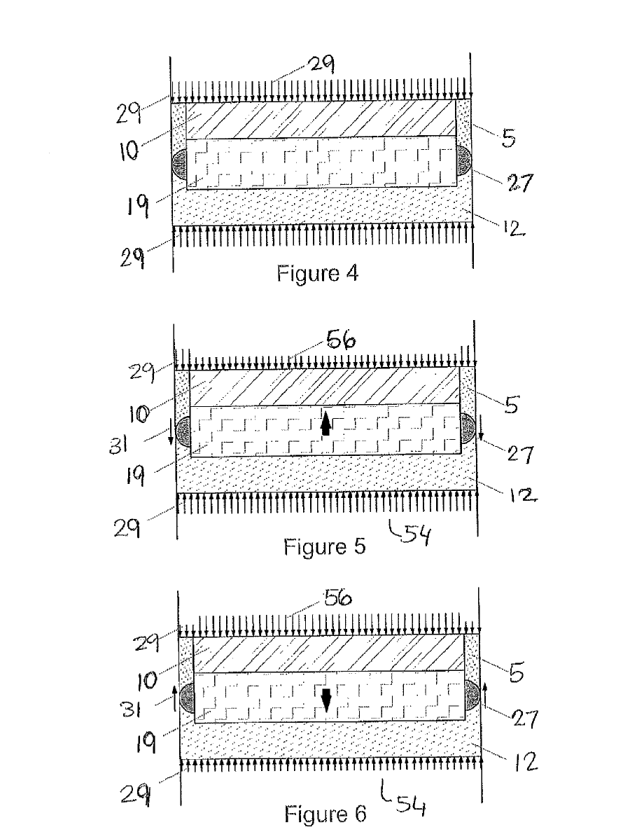

In this example of the first embodiment, the first fluid 5 is oil. The second fluid 12 is a molten metal or a molten metal alloy with low melting point (described further below). Using oil 5 and a molten metal 12 within the system 100 facilitates moving the bodies 10 with substantially minimal friction through the bore 110. Moving the bodies 10, substantially effortlessly with minimal energy loss, is described further below with reference to FIGS. 4, 5, and 6.

The system 100 illustrated in FIGS. 1 and 2 shows an arrangement where the moving bodies 10 can move in and out of the bore 110 when charging and discharging energy respectively. FIG. 1 illustrates a charged system where the bodies 10 are mainly contained in a suitable container 9 located at the surface. FIG. 2 illustrates a discharged system, where the bodies 10 have been released from the container 9 and occupy the area within the bore 110.

Similar to the pump storage system described above, movement of the bodies 10 to a charged status is achieved using fluid pressure by pumping the fluid 5 into the lower section and gravity is utilised to discharge the system.

In this example, the oil 5 that is stored in a tank 4 at atmospheric pressure at the surface at the top of the bore 110. To pressurise the system 100, oil 5 is pumped from the tank 4 towards the horizontal section 21 of the bore 110. The bore 110 is arranged to provide a U-tube configuration, which is described further below, with reference to FIG. 3a. A pressure differential is created and acts to push against and expel the upper fluid 12 (in this example a molten metal) acting on the upper side of a seal assembly 19, 27 (see FIGS. 4, 5 and 6) from the system to another tank 11. The level of molten metal or molten alloy 12 in the system 100 is intelligently controlled using a control system 15, which includes a suitable pump and pipework system 14 to maintain the levels of fluid 12 in the system 100.

The illustrated system 100 comprises connection to the grid 1 (a high-voltage electric power transmission network) and to a wind turbine 2. A single wind turbine 2 is illustrated; however it will be appreciated that this may represent a wind farm comprising a plurality of such wind turbines.

As with the pump storage system the energy generated from the system 100 will be mechanical energy, which is captured and converted to useful electrical energy. This step in the process will be achieved using suitable transformation/conversion components known to the skilled person and are indicated by reference numerals 3 and 7 in FIGS. 1 and 2.

In the illustrated example the grid 1 represents a large scale electricity supplier and the wind turbine 2 represents a small scale electricity supplier. It will be appreciated that the system 100 could be used with both the large scale system and the smaller scale system and may also operate with either system independently of the other. As such, it will be appreciated that if the energy storage system 100 is used only with a wind turbine arrangement demands upon the system would most likely be reduced and as such the scale of the excavation required may also be affected.

FIG. 3a illustrates a cross sectional plan view of the excavated bore 110 described above with reference to FIGS. 1 and 2. The arrangement illustrates a U-tube configuration where the runner fluid (in this case oil) 5 is supplied to an area below the seal assembly 19, 27 via tubes or pipes 16 that extend along the outside of a casing 17 inserted into the bore 110. The molten metal or metal alloy 12 is supplied to the bore 110 and also fills an annulus area that is defined by the space between the casing 17 and the bodies 10. The molten metal or molten metal alloy 12 also fills any voids between the bodies 10 such that the bodies 10 are effectively submerged in the molten metal 12. In the illustrated example the pipes 16 are secured between the casing 17 and a concrete layer 25.

The U-tube configuration in the illustrated embodiment comprises several small bore pipes 16 fastened to the casing 17 along the length of the bore 110. The runner fluid 5 is added to the lower region of the bore 110 via the pipes 16. The pipes 16 are open at the bottom 22 of the bore 110 and as such the central section of the bore 110 containing the bodies 10 is effectively in fluid communication with the pipes 16 only in the region below the seal assembly 19, 27 thus providing a U-tube configuration.

An alternative U-tube arrangement (not illustrated) may be achieved where the bore 110 comprises a pipe within a pipe system, where the outer pipe, for example the casing 17, has a closed end and an inner pipe is open and thus defines an annulus between the inner pipe and the casing (outer pipe). The annulus area would be fed with the runner fluid 5 and the inner pipe would contain the rigid moving bodies 10 and would be fed with the molten metal or the molten metal alloy 12.

In the illustrated embodiment the bodies 10 have a smaller diameter than the inner diameter of the bore 110. It will be appreciated that the diameter of the body 10 is smaller to minimise the risk of jamming in the bore 110. The size of the bodies 10 may be determined also based on the constraints presented due to the change in direction of the bore 110 from the vertical section 20 to the horizontal section 21.

The length of the body 10 may also be determined based on the dimension of the bore 110 and the constraints presented in view of the change in direction of the bore 110 from the vertical section 20 to the horizontal section 21.

FIGS. 3a and 3b show that the bodies 10 are mounted on rollers 24 such that the each body 10 can move within the bore 110 with minimal friction. The rollers 24 contact the inside of the bore 110 and facilitate transporting the body 10 along the bore 110. The rollers 24 also ensure a gap or clearance is maintained between the body 10 and the inside of the bore 110 such that the risk of jamming is minimised.

Referring to FIGS. 4, 5 and 6, the gap or clearance between the bodies 10 and the wall of the bore 110 and the gap or clearance between adjacent bodies 10 are filled with a relatively high density fluid 12. The seal assembly 19, 27 comprises a seal support 19 and a seal element 27. In the illustrated example the fluid 12 is a molten metal or a molten metal alloy such that the pressure at either side of the seal element 27 located beneath the bodies 10 is balanced and the seal assembly 19, 27 stationary. The second fluid 12 in the first embodiment of the present invention is a metal alloy 12 with a low melting point. The second fluid 12 has a density that is approximate the density of the bodies 10.

The oil 5 can be pumped into the U-tube configuration from the oil tank 4 to pressurise the column defined by the bore 110 containing the bodies 10. This results in upward movement of the seal assembly 19, 27 and the molten metal 12 being displaced out of the bore 110 for storage in the container 11 at the surface. Pumping of oil 5 can continue until all of the bodies 10 are displaced and all of the molten metal 12 is stored in its container 11. If the pump is stopped the molten metal 12 and the weight of the bodies 10 act to push the oil 5 back to the oil tank 4 since the molten metal 12 is denser than the oil 5. It will be appreciated that the pump now behaves as a hydraulic motor and turns while the oil passes through and releases the stored potential energy.

Hydraulic cylinders are widely used in lifting/shifting heavy loads in industry. However, such devices can generally only move heavy weights a few metres. In such a hydraulic tool a liquid (usually a specific type) is the driver liquid which acts to push a piston through a cylinder. The liquid is fully sealed within a chamber by the piston such that fluid pressure increases and creates the mechanical force required to displace the piston. In such an arrangement adequate sealing is critical because if the chamber is not sealed properly the liquid contained in the chamber would leak and the required pressure increase to effect mechanical displacement would not occur. A hydraulic lift mechanism requires accurate and advanced machining such that adequate sealing is achieved.

In the context of moving a body through a hole as described herein it will be appreciated that achieving such efficient sealing is very difficult and expensive. This is particularly relevant the depth of the bore 110 is the region of seven kilometres and where the vertical section around two kilometres deep.

Indeed, putting aside the impractical option of perfectly machining the interfaces, there is a pay-off, between the integrity of the seal and the friction losses encountered, when using a non-rigid seal (like rubber and elastomers). As the seal integrity is increased so that larger pressure and loads may be used, the friction losses increase.

The energy storage system illustrated in FIGS. 1 and 2 uses a fluid-to-fluid mechanism to overcome a sealing problem and to minimise friction losses between the seals 27, the moving bodies 10 and the wall of the bore 110. This arrangement is best illustrated and described with reference to FIGS. 4, 5 and 6.

FIGS. 4, 5 and 6 each illustrate pressure distribution about the interface region of the oil 5 and the molten metal 12. In FIG. 4 the system 100 is static, where the body 10 rests upon a seal assembly 19, 27 which supports the bodies 10 and also includes a seal element 27 that separates the oil 5 from the molten metal 12.

The function of the seal element 27 is to keep the fluids 5, 12 separated and therefore prevents mixing of the fluids 5, 12 and maintains a minimal pressure differential in the region of the seal element 27. The seal element 27 acts as the interface of the two fluids and as such there is substantially no pressure differential and substantially no load applied to the seal 27 in the region where the two fluids 5, 12 meet. The arrows 29 indicate the pressure distribution when the bodies 10 are stationary. Pressure distribution on both faces of the seal is balanced.

When the seal assembly 19, 27 is moved in order to charge or discharge the system, the pressure on either side of the seal assembly 19, 27 especially the seal support member 19 is different. However, this pressure difference is localised to the central area of the seal assembly 19, 27 (the seal support 19) and the pressure differences at the seal 27, near its interface with the wall of the bore 110, is less or minimised by manipulating the fluid pressure of the second fluid 12, as described below. In this way the seal 27 does not have to be compressed and pushed to the wall to achieve integrity which would cause significant friction losses, and be expensive.

The molten metal 12 and bodies 10 behave individually. The pressure within the molten metal 12 is a function of the fluid head and therefore if the molten metal 12 is denser than the bodies 20 having a relatively smaller head (column height in vertical section) the molten metal 12 can be at substantially the same pressure as the column of bodies 10 at the bottom of the bore 110. As such the bore 110 does not need to be full of molten metal.

A system 14, 15 (see FIGS. 1 and 2) controls the level of molten metal 12 and consequently also controls the pressure of the molten metal 12 in the region of the seal assembly 19, 27. The system 14, 15 comprises a pump, measuring instruments and control instruments. The function of the system 14, 15 is to feed or remove molten metal 12 to maintain the level of molten metal 12 in the bore 110 such that the pressure at the seal face is an appropriate level.

The surface area occupied by the seal assembly 19, 27 is fully covered on one side by oil 5 however on the opposite side, the surface area of the seal assembly 19, 27 is divided between a body 10 and the molten metal 12 where the body 10 covers most of the seal area 19 and remaining area occupied by the seal element 27 is covered by the molten metal 12.

FIGS. 5 and 6 illustrate the pressure distribution 54, 56 whilst the system 100 is charging and discharging respectively.

In FIG. 5, the runner fluid pressure 54 acting on the body 10 increases whilst the system is charging and is greater than the pressure due to the bodies 10, the molten metal 12 and frictional effects 31 of the movement within the bore 110. The fluid pressure acting on the body 10 due to the molten metal 12 is higher than the pressure applied by the bodies 56. As such the level of molten metal 12 is adjusted by the control system such that the pressure about the seal element 27 covered by both fluids is substantially balanced.

In FIG. 6, the system is illustrated in discharging state (energy release) due to gravity. The runner fluid pressure 54 acting on the body 10 combined with the frictional effects 31 is less than the pressure due to the bodies 10 and the molten metal 12 as such downward movement of the bodies occurs within the bore 110. As such the level of molten metal 12 is adjusted by the control system 14, 15 (see FIGS. 1 and 2) and the pressure about the seal element 27 covered by both fluids is substantially balanced.

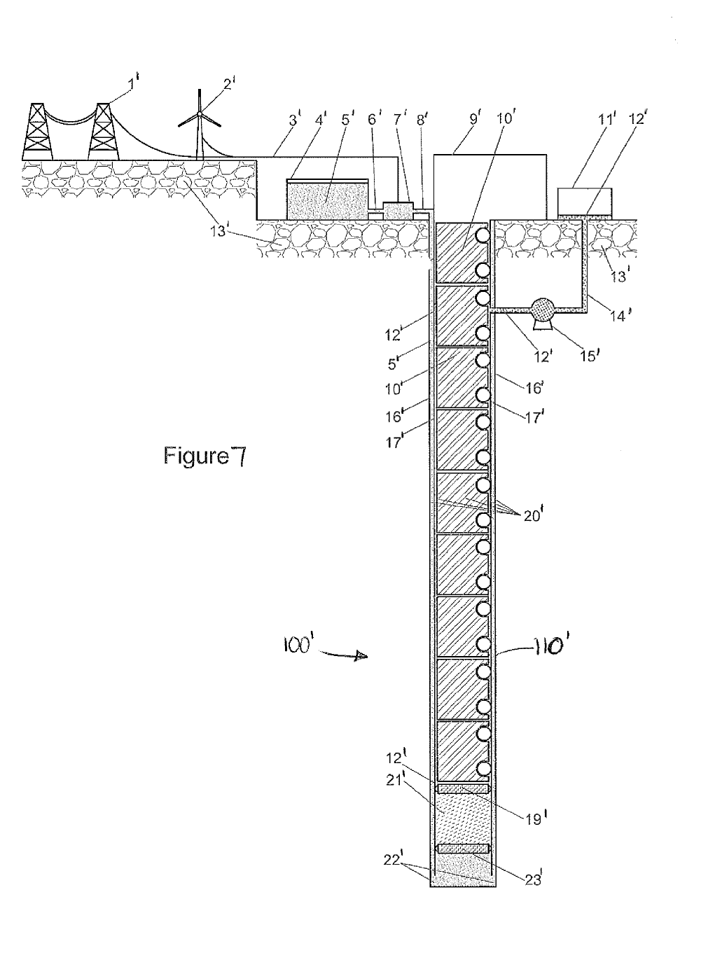

The seal element 27 is effective in separating the fluid elements 5, 12 of the energy storage system 100, but is not required to actively provide a seal against the wall of the bore 110. As such frictional effects 31 of the seal element 27 during charging and discharging are substantially absent. As such the first embodiment of the present invention utilises a fluid-fluid hydraulic mechanism to overcome a problem with friction and therefore to also overcome energy losses due to sealing issues. The second embodiment of the present invention, described below with reference to FIGS. 7, 8, 9a, 9b, 10 to 12, 13a and 13b also utilises a fluid-fluid hydraulic mechanism to overcome a problem with friction and therefore to also overcome energy losses due to sealing issues.

As is apparent from the examples illustrated in FIGS. 4, 5 and 6 the seal assembly 19, 27 is subjected to pressure from the runner fluid 5 on one face and on the opposite face is subject to pressure from the bodies 10 and the molten metal 12. The seal element 27 is arranged to be only subject to pressure from the oil 5 on one face and subject to pressure from the molten metal 12 on the opposite face. The seal element 27 is therefore subject to the fluid interface pressure, which can be compared with the situation where two insoluble fluids are in contact. As such the seal element 27 is substantially free from loading.

The equilibrium condition provided at the seal element 27 can be illustrated by an example where two insoluble liquids with different densities like oil and mercury are poured into a U-tube. In equilibrium, the interface pressure is equal in both the oil and the mercury.

To avoid direct contact and possible mixing contamination of the fluids a rubber element can be used to separate the two fluids. Since the pressure is equal on both faces of the rubber neither fluid is found to leak to the other side. The rubber element acts only as a separator to avoid mixing of the fluid. This principle is applied in the energy system 100 as described above with reference to FIGS. 4, 5 and 6.

As described above, the illustrated embodiment uses oil and molten metal as the fluids in the system. Molten metal 12 was selected to provide a fluid with the desired density to achieve the movement of the bodies 10 and to achieve the balanced pressure at the seal element 27.

Theoretically, mercury was found to provide a fluid with the desired density. Bromine and Iodine or their components were also found to be suitable. However, regardless of the technical and environmental issues relating to using such material the prohibitive costs found these to be unsuitable.

Water was considered an impractical option due to the scale of the bore hole required.

Molten or liquid metal 12 provides a fluid with the physical properties required to balance pressure with the runner fluid 5 at the seal element 27. Examples of suitable alloys are: eutectic alloy and some non-eutectic alloys. A eutectic alloy is a mixture of metal compounds having a unique single chemical composition and a unique melting point, which is generally lower than the melting point of each of its constituent parts.

Alloys with low temperature melting points are commonly known as fusible alloys or low melting point bismuth based alloys. Alloys having a melting point lower than 70° C. are preferable to be used as the liquid metal. These alloys in liquid form can be corrosive therefore this should be considered when selecting a suitable alloy.

Low melting point metal alloys are widely used in industry and are inexpensive compared with mercury. In addition, low melting point metal alloys are generally not harmful to the environment and are not toxic.

Some well known low temperature melting alloys are listed below together with their density, which is higher than the density of the steel. The density of steel is 7850 kg/m³. It will be appreciated that the bodies 10 may be made from steel or a composition including steel.

| Name | Melting Point | Density |
|---|---|---|
| Wood's Metal | 70° C. | 9380 kg/m³ |
| Field's Metal | 62° C. | 9700 kg/m³ |
| Cerrolow 136 | 57° C. | 8570 kg/m³ |
| Cerrolow 117 | 47.2° C. | 8860 kg/m³ |

In order to maintain the molten metal 12 in a molten state it will be appreciated that the bore 110 and the container 11 need to be maintained at a temperature to keep the molten metal or metal alloy as a fluid.

In the illustrated embodiment the vertical section of the bore 20 is at least two kilometres deep and as such the horizontal section 21 can be warmed by naturally occurring geothermal energy. Away from tectonic plate boundaries the geothermal gradient is about 25-30° C. per kilometre (km) of depth in most of the world. Therefore in a bore of around three kilometre depth the temperature is expected to be in the region of 75° C. which should be sufficiently warm to maintain the metal/alloy in a fluid state.

To avoid loss of heat from the vertical section of the bore 20 insulation material such as aerogels or polyurethane may be suitable because such materials have low thermal conductivity.

Calculation shows that the heat lost along a vertical section of a 14-inch well with depth of 3000 m which is covered by a thick insulating material with thermal conductivity of 0.1 W/mK is about 0.2 MW, assuming average temperature difference of 30° C. along the well.

To cover the heat lost a liquid can be circulated in a coil along the horizontal section 21 of the well. This liquid should absorb the heat from a source of thermal energy and distributes the heat along the vertical section 20 to keep the well temperature above the required level.

An alternative source of heat may be generated by capturing energy losses from any ancillary equipment such as the energy transformation system 7. The energy transformation system 7 may be in the region of 80% efficient, which means that 20% of the energy is lost to heat. As such the heat can be reused and transferred to the bore 110 to maintain the temperature.

An advantage of the first embodiment is the iron body and molten metal are dense materials which provide more of an energy storage capacity per volume.

A second embodiment of the present invention is described with reference to FIGS. 7, 8, 9a, 9b, 10-12, 13a and 13b. For ease of understanding like reference numerals including an apostrophe (') have been applied to the reference numerals to correspond with common features of the first embodiment as illustrated in FIGS. 1, 2, 3a, 3b and 4 to 6 above.

Other than the fluid types and material for the bodies, the second embodiment operates on the same principles. Accordingly various features from the first embodiment are equally applicable to the second embodiment. Like parts have generally not been described again.

In contrast to the first embodiment, the second embodiment the first fluid 5′ is water and the second fluid 12′ is a suspension. Moreover the bodies may be made from concrete. Whilst these materials are less dense, the suspension does not require heating to maintain it in a liquid form. Moreover the materials are less expensive.

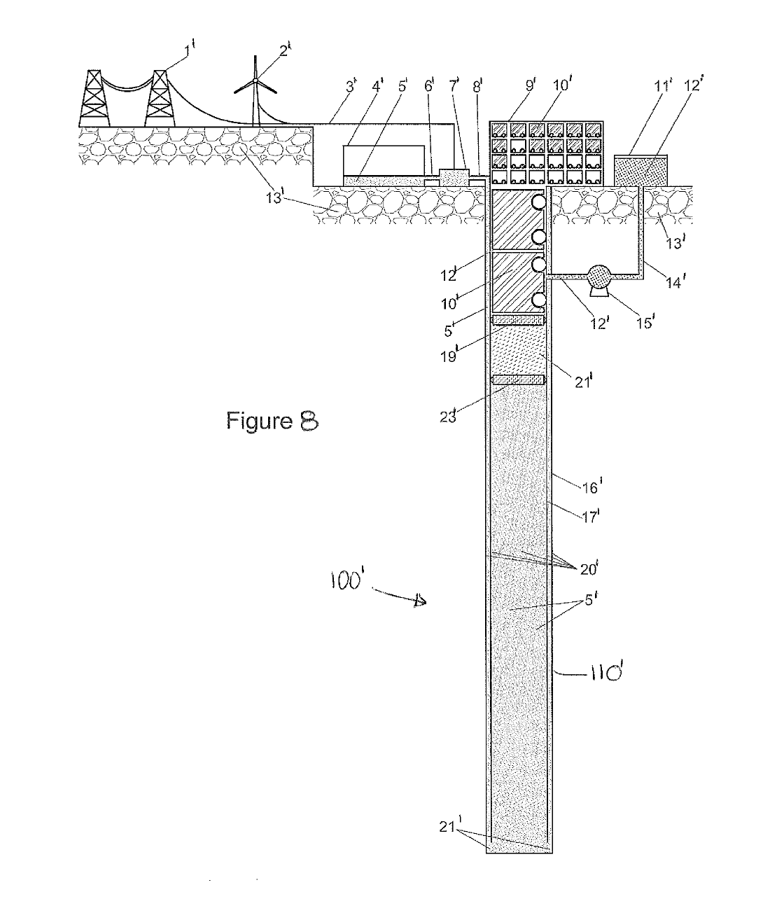

FIG. 7 illustrates an example of an energy storage system 100′ in accordance with a second embodiment of the present invention. FIGS. 7 and 8 schematically represent an energy storage system 100′ connected to the electrical grid 1′ and a wind turbine 2′. As described above with respect to the first embodiment the energy storage system 100′ works on a similar principle as the prior art pump storage system where energy is stored and discharged by moving a mass/weight within the system.

In order for the bodies 10′ to move along the length of the bore 110′, the illustrated embodiment utilises a runner fluid 5′ that is fed to the lower regions of the bore 110′ (below the bodies 10′) via pipes 16′ that extend along the edge of the bore 110′ within the casing 17. The pipes 16′ are open at the top to receive fluid and open at the bottom 22′ to expel fluid 5′ into the lower region of the bore 110′. The system also utilises a second fluid 12′ as described for the first embodiment.

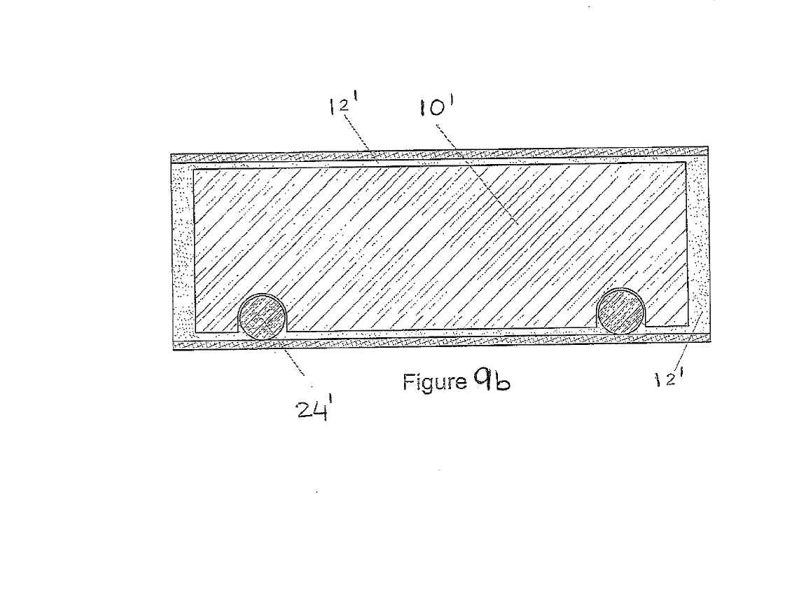

In contrast to the earlier embodiment, the first fluid 5′ in this embodiment is water and the second fluid 12′ is a suspension. A suspension is a heterogeneous mixture containing solid particles that are sufficiently large for sedimentation. The solid particles, known as the internal phase, are dispersed in a fluid, known as the external phase. The suspension 12′ for use with the energy storage system 100′ has a density close to the density of the bodies 10′. This arrangement allows the pressure upon the seal element 27′ to be balanced as discussed further below with reference to FIGS. 10, 11 and 12.

Preferably, an increase in the density of the second fluid 12′, in this embodiment a suspension, and of the bodies 10′ results in a decrease in the overall volume of the system and therefore reduces the depth required for the bore 110′. As such excavation of such a bore 110′ and the overall system 100′ is more economical.

An example of a second fluid 12′ is a suspension mixture comprising a metal powder suspended in oil. Metal powders generally comprise metal particles that have been compressed and bound together by applying pressure to form a solid. An example of a suitable suspension uses oil (external phase) and iron powder (internal phase). Such a suspension has a density of around 2800 kg/m³.

Any reference to a second fluid 12′ in the following means a suspension comprising oil and metal powder.

By its nature the metal powder suspended in the oil will settle (separate) if the mixture is left static and undisturbed. As such to maintain the metal powder suspended in the oil, the system 100′ includes agitation means which agitates the suspension 12′ such that settlement/separation of the metal powder does not occur.

The suspension 12′ can be agitated or mixed in many ways including but not limited to the following:

Partial or full agitation may occur during charging and discharging of the energy storage system 100′, wherein the bodies 10′ move within the bore 110′.

The suspension 12′ fills an annulus area defined between the bodies 10′ and the bore 110′ and any gaps between adjacent bodies 10′. As such agitation occurs as a result of the movement of bodies 10′ relative to the bore wall 110′ because the shearing force between the suspension 12′ and the solid surfaces provided by the bore wall 110′ and the moving bodies 10′ provide a means of continuous agitation of the suspension 12′.

Alternatively, agitation can be provided by an external source such as circulating the suspension 12′ using a pump arrangement (not illustrated). A mixing device may be used to stir/agitate the suspension 12′, for example in the holding tank 11′ such that the metal powder does not settle.

Where the metal powder comprises, for example, iron powder a magnetic system could be employed to provide agitation of the suspension 12′ as it moves through the system 100′. An example of using a magnetic source could be provided by an electrical current in a coil that is wrapped around the bodies 10′ or the bore casing 17′. Magnetic pulses passing through the coil may be effective in attracting the iron element of the metal powder and thereby agitate the suspension 12′ and maintain dispersion of the metal powder in the oil.

Alternatively, a magnetic field may be provided by a permanent magnet arrangement that can rotate or move within the system 100′.

Using a runner fluid 5′ and a suspension 12′ within the system 100′ facilitates moving the bodies 10′ with substantially minimal friction through the bore 110′. Moving the bodies, substantially effortlessly with minimal energy loss, is described further below with reference to FIGS. 10, 11 and 12.

The runner fluid 5′ could be either oil or water. In this particular embodiment the runner fluid 5′ is water. In the illustrated embodiment the interface region includes a relatively short column of oil 21′ below a main seal assembly 19′, 27′ and a secondary seal assembly 23′ (see FIGS. 7 and 8) that is operable to avoid direct interface between the runner fluid 5′(water), and the suspension 12′. As such, oil 21′ is trapped between the main and secondary seal assemblies 19′ & 27′, 23′.

The system 100′ illustrated in FIGS. 7 and 8 shows an arrangement where the moving bodies 10′ can move in and out of the bore 110′ when discharging and charging energy respectively. FIG. 7 illustrates the discharged system, where the bodies 10′ have been released from a suitable container 9′ and occupy the area within the bore 110′. FIG. 8 illustrates a charged system where the bodies 10′ are mainly contained in the container 9′ located at the surface.

Similar to the pump storage system, movement of the bodies 10′ to a charged status is achieved using fluid pressure by pumping the fluid 5′ into the lower section and gravity is utilised to discharge the system.

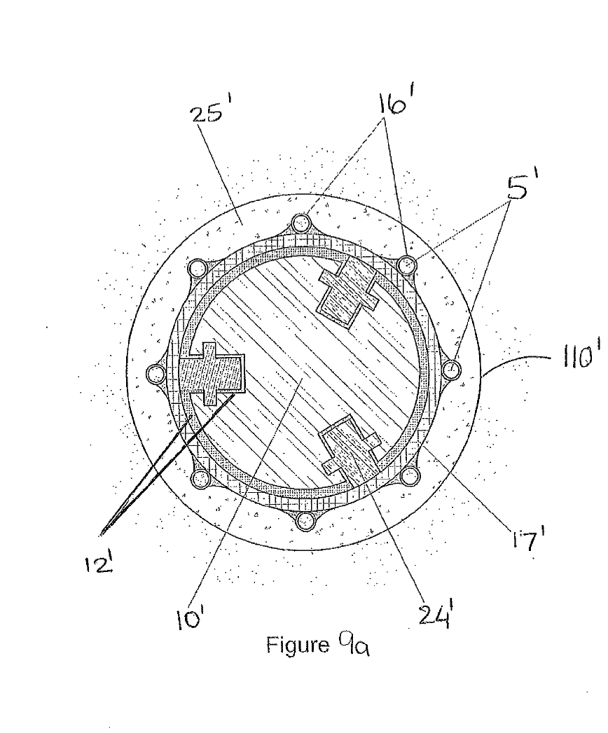

In the illustrated example, water 5′ is stored in a tank 4′ at atmospheric pressure at the surface at the top of the bore 110′. To pressurise the system 100′, water 5′ is pumped from the tank 4′ towards the bottom of the bore 110′. The bore 110′ is arranged to provide a U-tube configuration, which is described further below with reference to FIG. 9a. A pressure differential is created and acts to push against and expel the suspension 12′ acting on the upper side of the seal assembly 19′, 27′ (see FIGS. 7 and 8) from the system to another tank 11′. The level of suspension 12′ in the system 100′ is intelligently controlled using a control system 14′, 15′, which includes a suitable pump and pipework system 14′ to maintain the levels of suspension 12′ in the system 100′ such that the pressure acting on the seal element 27′ (see FIGS. 10, 11 and 12) is substantially balanced.

During charging, a pump arrangement (not illustrated) draws water 5′ from the tank 4′, pressurises the water 5′ and injects it into the U-tube arrangement. The pressurised water 5′ pressurises the trapped interface oil 21′ such that the oil pressure behind the cylindrical seal assembly 19′, 27′ pushes the bodies 10′ up to ground level to the storage area 9′.

The illustrated system 100′ comprises connection to the grid 1′ (a high-voltage electric power transmission network) and to a wind turbine(s) 2′.

As with the earlier embodiment, the energy generated from the system 100′ will be mechanical energy, which is captured and converted to useful electrical energy. This step in the process will be achieved using suitable transformation/conversion components known to the skilled person and are indicated by reference numerals 3′ and 7′ in FIGS. 7 and 8.

FIG. 9a illustrates a cross sectional plan view of the excavated bore 110′ described above with reference to FIGS. 7 and 8 and akin to FIG. 3a of the earlier embodiment, like part not being described further.

In the illustrated embodiment the bodies 10′ have a smaller diameter (for example 5% to 10% less) than the inner diameter of the bore 110′. It will be appreciated that the diameter of the body 10′ is smaller to minimise the risk of jamming in the bore 110′.

The length of the body may also be determined based on the dimension of the bore 110′.

Water 5′, as the runner fluid, can be pumped into the U-tube configuration from the tank 4′ to pressurise the column defined by the bore 110′ containing the bodies 10′. This results in the suspension 12′ being displaced out of the bore 110′ for storage in the container 11′ at the surface. Pumping of water 5′ can continue until all of the bodies 10′ are displaced and all of the suspension 12′ is stored in its container 11′. The system may otherwise function in a manner described for the earlier embodiment. The energy storage system illustrated in FIGS. 7 and 8 uses a fluid-to-fluid mechanism to overcome a sealing problem and to minimise effects of friction between seals 27′, moving bodies 10′ and the wall of the bore 110′. This arrangement is illustrated and described with reference to FIGS. 10, 11 and 12.

FIGS. 10, 11 and 12 each illustrate pressure distribution about the interface region of the runner fluid 5′, and the suspension 12′. In FIG. 10 the system 100′ is static, where the body 10′ is shown adjacent a seal assembly 19′, 27′ which supports the bodies 10′ and also includes a seal element 27′ that separates the runner fluid 5′, or trapped oil, from the suspension 12′.

The function of the seal element 27′ is to keep the first and second fluids 5′, 12′ separated and therefore prevents mixing of the fluids 5′, 12′ and maintains a minimal pressure differential in the region of the seal element 27′. The seal element 27′ acts as the interface of the two fluids and as such there is substantially no pressure differential and substantially no load applied to the seal 27′ in the region where the two fluids 5′, 12′ meet. Arrows 29′ indicate the pressure distribution when the bodies 10′ are stationary. Pressure distribution on both faces of the seal element 27′ is balanced.

When the seal assembly 19′, 27′ is moved in order to charge or discharge the system, the pressure on either side of the seal assembly 19′, 27′ is different. However, this pressure difference is localised to the central area of the seal support 19 and the pressure differences at the outer edge of the seal 27′, near its interface with the wall of the bore 110′, is less or minimised by manipulating the fluid pressure of the second fluid 12′, as described below. In this way the seal 27′ does not have to be of such integrity which would cause significant friction losses, and be expensive.

The suspension 12′ and bodies 10′ behave individually. The pressure within the suspension 12′ is a function of the fluid head and therefore if the suspension 12′ is denser than the bodies 10′ having a relatively smaller head (column height) the suspension 12′ can be at substantially the same pressure as the column of bodies 10′ at the bottom of the bore 110′. As such the bore 110′ does not need to be full of suspension 12′.

A system 14′, 15′ (see FIGS. 7 and 8) controls the level of suspension 12′ and consequently also controls the pressure of the suspension 12′ in the region of the seal assembly 19′, 27′. The system 14′, 15′ comprises a pump, measuring instruments and controlling instruments. The function of the system 14′, 15′ is to feed or remove suspension 12′ to maintain a volume/level of suspension in the bore 110′ such that the pressure at the seal face is an appropriate level.

The surface area occupied by the seal assembly 19′, 27′ is fully covered on one side by runner fluid 5′; however, on the opposite side, the surface area of the seal assembly 19′, 27′ is divided between contact with a body 10′ and the suspension 12′ where the body 10′ covers most of the seal area 19′ and remaining area is covered by the suspension 12′.

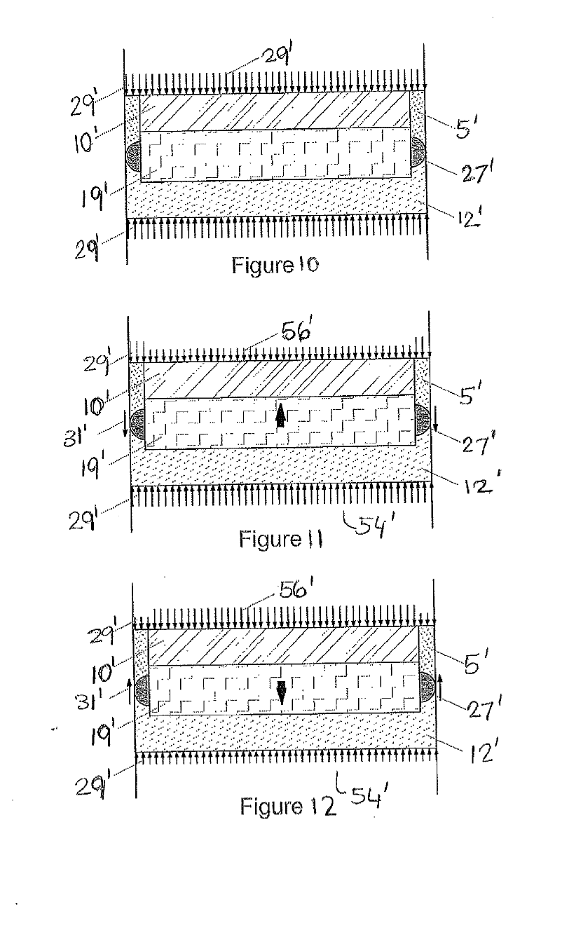

FIGS. 11 and 12 illustrate the pressure distribution 54′, 56′ whilst the system 100′ is charging and discharging respectively.

In FIG. 11, the runner fluid pressure 54′ acting on the body 10′ increases whilst the system is charging and is greater than the pressure due to the bodies 10′, the suspension 12′ and frictional effects 31′ of the movement within the bore 110′. The fluid pressure acting on the body 10′ due to the suspension 12′ is higher than the pressure applied by the bodies 56′. As such the level of suspension 12′ is adjusted by the control system 14′, 15′ (see FIGS. 7 and 8) such that the pressure about the seal element 27′ covered by both fluids is substantially balanced.

In FIG. 12, the system is illustrated in status of discharge (energy release) due to gravity. The runner fluid pressure 54′ acting on the body 10′ combined with the frictional effects 31′ is less than the pressure due to the bodies 10′ and the suspension 12′ such that downward movement of the bodies occurs within the bore 110′. As such the level of suspension 12′ is adjusted by the control system 14′, 15′ (see FIGS. 7 and 8) such that the pressure about the seal element 27′ covered by both fluids is substantially balanced.

The seal element 27′ is effective in separating the fluid elements 5′, 12′ of the energy storage system 100′, but is not required to actively provide a seal against the wall of the bore 110′. As such frictional effects 31′ of the seal element 27′ during charging and discharging are substantially absent. As such the second embodiment of the present invention, as with the first embodiment described above, utilises a fluid-fluid hydraulic mechanism to overcome a problem with friction and therefore to also overcome energy losses due to sealing issues. The pressure head of the second fluid 12′ is controlled by the control system 14′, 15′ (see FIGS. 7 and 8) such that the energy storage and recovery system 100′ operates as efficiently as possible

As is apparent from the examples illustrated in FIGS. 10, 11 and 12 the seal assembly 19′, 27′ is exposed to the runner fluid 5′ on one face and on the opposite face is exposed in part to the body 10′ and is exposed in part (the seal element) to the suspension 12′. The seal element 27′ is arranged to be exposed only to the runner fluid 5′ (water) on one face and the suspension 12′ on the opposite face. The seal element 27′ is subject to the interface pressure, which can be compared with the situation where two insoluble fluids are in contact. As such the seal element 27′ is substantially free from loading.

The equilibrium condition provided at the seal element 27′ can be illustrated by an example where two insoluble liquids with different densities like oil and mercury are poured into a U-tube. In equilibrium, the interface pressure is equal in both the oil and the mercury.

To avoid direct contact and possible mixing contamination of the fluids a rubber element can be used to separate the two fluids. Since the pressure is equal on both faces of the rubber element neither fluid is found to leak to the other side. The rubber element acts only as a separator to avoid mixing of the fluid. This principle is applied in the energy system 100′ as described above with reference to FIGS. 10, 11 and 12.

As described above, the illustrated embodiment uses water and a suspension of metal powder in oil as the fluids 5′, 12′ in the system. Alternatively, the runner fluid 5′ could be oil. A suspension 12′ comprising oil and metal powder was selected to provide a fluid with the desired density to achieve the movement of the bodies 10′ and to achieve the balanced pressure at the seal element 27′.

Suspension 12′ provides a fluid with the physical properties required to balance pressure with the runner fluid 5′ at the seal element 27′. Examples of suitable suspensions are: iron powder mixed with oil or lead powder mixed with oil.

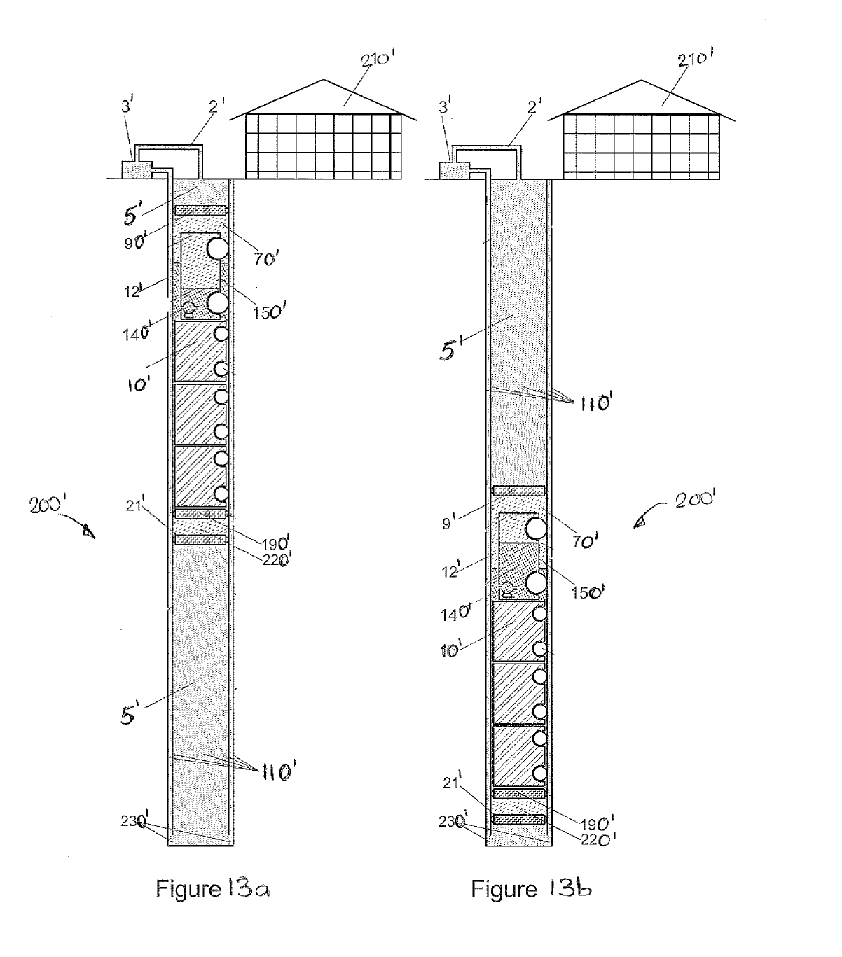

FIGS. 13a and 13b illustrate an application of the energy storage and recovery system described above as applied to supply energy to a supermarket or shopping centre.

There are approximately six thousand supermarkets and superstores in the UK with average energy consumption of 300 kW each. If all of the stores were connected to an energy storage system according to the embodiments of the present invention peak demand could be decreased by around 1800 MW.

A single energy storage system 200′ is adequate to cover the energy storage and delivery requirement of a business or shopping centre 210′. In illustrated energy storage system 200′ the bodies 10′ always remain within the bore 110′. Such a system uses half of the maximum potential capacity of the system described above where the bodies are expelled from the bore 110′.

In the system illustrated in FIGS. 13a and 13b the runner fluid 5′ maintains constant pressure, which requires a simple energy transformation system, has low operating cost and does not require additional storage space above ground.

The system 200′ operates during charging (energy storage) to extract water 5′ from the bore 110′, pressurises the water 5′ and injects it into the hydraulic U-tube mechanism 230′. The water pressurises trapped interface oil 220′. The oil pressure behind the cylindrical seal 190′ pushes the bodies 10′ up through the bore 110′.

When energy recovery is required the bodies 10′ are released and travel down through the bore 110′ and actively push the water 5′ back through a motor or turbine. The motor or turbine operates a generator 300′ to provide electricity to the shopping centre or store 210′.

This system requires a column of trapped oil 70′ at the top of bore 110′. A seal element 90′ separates the runner fluid 5′ from the bodies 10′.

In the illustrated embodiment the runner fluid is water 5′ and as such a controlling system 140′, 150′ to control the level of suspension 12′ within the bore 110′ is required. In the illustrated embodiment a mobile control system 150′, operable to control the level of suspension 12′ within the bore 110′ is also located within the bore 110′ above the bodies 10′. Common to both embodiments described above.

The energy transformation system may include, an electrical motor-hydraulic pump combination for storing the energy (transferring electrical energy to mechanical potential energy) and a hydraulic motor-electrical generator combination for realising the energy (transferring mechanical potential energy to electrical energy). A hydraulic pump and a hydraulic motor have similar operating properties. An electrical motor and an electrical generator have similar operating properties. If these combinations are designed to be switchable a single hydraulic-electrical system could facilitate energy storage and energy generation. Such an arrangement could effectively reduce the overall cost of the system according to the present invention.

The energy storage system according to the present invention may be employed directly with an existing wind turbine or wind turbine farm via electrical connection. As such excessive electrical energy generated by the turbine can be used in charging the energy storage system 100, 100′. Similarly, where there is extra demand for electricity the energy storage system 100, 100′ operated to generate the electricity and transfers it to the grid. In this example energy transformation requires: mechanical (wind) to electrical (turbine generator) transformation, electrical to mechanical (energy storing process) and finally mechanical to electrical (energy generation process). Energy losses may be incurred due to the various steps. However, losses in energy during charging and discharging via the energy storage system shall be maintained at a minimum due to the arrangement described above.

Examples of electrical-mechanical energy transformation systems referred to above are well known in the industry at present and as such the detail of a suitable transformation system has been excluded.

Within the context of the present invention, the use of such an energy system with wind turbines may include storage of wind energy directly with the energy storage system 100, by connection for example to a hydraulic pump that forms part of the energy storage system. Such an arrangement is expected to increase the system efficiency and also reduce costs because the first step described above of mechanical to electrical would be eliminated and as such the energy storage system and the wind turbine can share one electrical generator.

Whilst specific embodiments of the present invention have been described above, it will be appreciated that departures from the described embodiments may still fall within the scope of the present invention.

1. An energy storage and recovery system comprising:
at least one movable body being arranged to move within a bore excavated underground;
a seal assembly arranged to support the at least one body for movement in two directions within the bore, wherein the seal assembly comprises a support member and a seal element, wherein the seal assembly is adapted to isolate two regions within the bore from each other;
a fluid loading system wherein a first fluid and a second fluid can be separately fed to the bore;
wherein in use the first fluid applies pressure adjacent a first face of the seal element, wherein the first fluid can be pressurised to charge the energy storage system and a second fluid comprising fluid of heavier density than the first fluid;
wherein the second fluid applies pressure adjacent a second face of the seal element; and
wherein the fluid loading system is operable to control levels of the second fluid within the bore.

2. The energy storage system according to claim 1, wherein the first fluid comprises oil.

3. The energy storage system according to claim 1, wherein the second fluid comprises a molten metal or a molten metal alloy.

4. The energy storage system according to claim 3, wherein the molten metal alloy has a melting point of less than 70 degrees centigrade.

5. The energy storage system according to claim 3, wherein the metal alloy comprises at least one of the following options: a eutectic alloy or a non-eutectic alloy, a bismuth-based alloy or a fusible alloy or mercury or a mercury alloy.

6. The energy storage system according to claim 1, further comprising heating means operable to heat at least the second fluid.

7. The energy storage system according to claim 6, wherein the heating means comprises at least one of the following options: geothermal energy; heat supplied to the bore from an external source or waste energy from ancillary equipment connected to the energy storage system.

8. The energy storage system according to claim 1, wherein the bore includes a liner of insulation.

9. The energy storage system according to claim 1, wherein the first fluid comprises water or oil.

10. The energy storage system according to claim 9, wherein the second fluid comprises a suspension of particulate material dispersed in an external phase of fluid.

11. The energy storage system according to claim 10, wherein the second fluid comprises a suspension of particulate material dispersed in oil.

12. The energy storage system according to claim 9, wherein the particulate material comprises at least one of the following: metal powder, iron powder or lead powder.

13. The energy storage system according to claim 10, further comprising agitation means operable, in use, to agitate the suspension of particulate material and fluid.

14. The energy storage system according to claim 13, wherein agitation of the suspension is provided by at least one of the following: movement of the at least one body, in use, to store or recover to partially energy, a pump arrangement adapted to circulate the suspension; a mixing device; a magnetic system operable to provide agitation of the suspension fluid as the fluid moves through the bore.

15. The energy storage system according to claim 14, wherein the magnetic system is provided by at least one of the following: a coil wrapped around the bodies, a coil wrapped around the bore casing or a permanent magnet arrangement that is operable to rotate or move within the bore.

16. The energy storage system according to claim 1, wherein, in use, when in the bore the at least one body is immersed in the second fluid.

17. The energy storage system according to claim 1, wherein, the density of the second fluid is substantially the density of the at least one body.

18. The energy storage system according to claim 1, wherein the at least one body is locatable proximate a side of the support member that corresponds with the second face of the seal element.

19. The energy storage system according to claim 1, wherein the bore comprises a plurality of pipes extending longitudinally at the perimeter of the bore, wherein each pipe is open towards the base of the bore, wherein the first fluid can be fed through the pipes and the second fluid can be fed to the bore.

20. The energy storage system according to claim 19, wherein, in use the fluid loading system controls the level of second fluid and consequently controls the pressure of the second fluid in the region of the seal assembly.

21. The energy storage system according to claim 20, wherein the fluid control system is configured to feed or remove the second fluid such that a volume of second fluid is maintained in the bore such that pressure at the second face of the seal element is maintained at an appropriate level to correspond with the pressure at the first face of the seal element.

22. The energy storage system according to claim 1, wherein the body comprises a substantially cylindrical body.

23. The energy storage system according to claim 1, wherein the body is solid.

24. The energy storage system according to claim 1, wherein the body comprises a hollow shell filled with solid matter.

25. The system according to claim 22, wherein the body comprises steel or iron.

26. (canceled)

27. The system according to claim 25, wherein the body is filled with concrete.

28. The energy storage system according to claim 1, wherein each body comprises a plurality of roller members distributed substantially evenly about the perimeter of the body.

29. The energy storage system according to claim 28, wherein each roller is arranged to rotate as the body passes through the bore.

30. The energy storage system according to claim 1, wherein the bore comprises a substantially vertical section and a substantially horizontal section extending from the bottom of the substantially vertical section.
